(19) United States
(12) Patent Application Publication
(10) Pub. No.: US 2024/0428991 A1
(43) Pub. Date: Dec. 26, 2024

(54) STACKED CAPACITOR ASSEMBLY AND METHOD OF MANUFACTURING THE SAME, AND STACKED CAPACITOR PACKAGE STRUCTURE

(71) Applicant: APAQ TECHNOLOGY CO., LTD., Miaoli County (TW)

(72) Inventors: CHIEH LIN, HSINCHU COUNTY (TW); CHENG-JHE SIE, Miaoli County (TW); YI-YING WANG, Hsinchu City (TW)

(21) Appl. No.: 18/417,037

(22) Filed: Jan. 19, 2024

(30) Foreign Application Priority Data
Jun. 20, 2023 (TW) 112123044

(51) Int. Cl. H01G 4/012; H01G 4/008; H01G 4/30

(52) U.S. Cl. CPC H01G 4/012; H01G 4/008; H01G 4/30

(57) ABSTRACT

A stacked capacitor assembly and a method of manufacturing the same, and a stacked capacitor package structure are provided. The stacked capacitor assembly includes a plurality of conductive substrates, an inner conductive structure and an outermost covering structure. Each of the conductive substrates has a first portion and a second portion opposite to the first portion. The inner conductive structure is configured to cover the first portion of each of the conductive substrates and be disposed between any two adjacent ones of the conductive substrates. The outermost covering structure is configured to cover the inner conductive structure. The inner conductive structure is provided without carbon-containing materials or silver-containing materials, and a space is formed between any two adjacent ones of the conductive substrates without carbon-containing materials or silver-containing materials.

### CROSS-REFERENCE TO RELATED PATENT APPLICATION

This application claims the benefit of priority to Taiwan Patent Application No. 112123044, filed on Jun. 20, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a capacitor assembly and a method of manufacturing the same, and a capacitor package structure, and more particularly to a stacked capacitor assembly and a method of manufacturing the same, and a stacked capacitor package structure.

### BACKGROUND OF THE DISCLOSURE

Applications of capacitors include being widely used in home appliances, computer motherboards and peripherals, power supplies, communication products and automobiles. The capacitors are mainly used to provide functions such as filtering, bypassing, rectifying, coupling, blocking and transforming, and such capacitors have become an indispensable component in electronic products. However, there is still room for improvement in the related art of the capacitor.

### SUMMARY OF THE DISCLOSURE

In response to the above-referenced technical inadequacy, the present disclosure provides a stacked capacitor assembly and a method of manufacturing the same, and a stacked capacitor package structure.

In order to solve the above-mentioned problems, one of the technical aspects adopted by the present disclosure is to provide a stacked capacitor assembly, which includes a plurality of conductive substrates, an inner conductive structure and an outermost covering structure. Each of the conductive substrates has a first portion and a second portion opposite to the first portion. The inner conductive structure is configured to cover the first portion of each of the conductive substrates and be disposed between any two adjacent ones of the conductive substrates. The outermost covering structure is configured to cover the inner conductive structure. The inner conductive structure is provided without carbon-containing materials or silver-containing materials, and a space is formed between any two adjacent ones of the conductive substrates without carbon-containing materials or silver-containing materials.

In order to solve the above-mentioned problems, another one of the technical aspects adopted by the present disclosure is to provide a method of manufacturing a stacked capacitor assembly, which includes providing a plurality of conductive substrates, in which each of the conductive substrates has a first portion and a second portion opposite to the first portion; arranging the conductive substrates to be spaced apart from each other; forming an inner conductive structure for covering the first portion of each of the conductive substrates and filling between any two adjacent ones of the conductive substrates; and forming an outermost covering structure for covering the inner conductive structure. The inner conductive structure is provided without carbon-containing materials or silver-containing materials, and a space is formed between any two adjacent ones of the conductive substrates without carbon-containing materials or silver-containing materials.

In order to solve the above-mentioned problems, yet another one of the technical aspects adopted by the present disclosure is to provide a stacked capacitor package structure, which includes a stacked capacitor assembly, an electrode assembly, an electrode assembly and an insulating package body. The stacked capacitor assembly includes a plurality of conductive substrates, an inner conductive structure and an outermost covering structure. The electrode assembly includes a first electrode structure and a second electrode structure respectively electrically connected to the stacked capacitor assembly. The insulating package body is configured to cover the stacked capacitor assembly and carry the electrode assembly. Each of the conductive substrates has a first portion and a second portion opposite to the first portion. The inner conductive structure is configured to cover the first portion of each of the conductive substrates and be disposed between any two adjacent ones of the conductive substrates. The outermost covering structure is configured to cover the inner conductive structure. The inner conductive structure is provided without carbon-containing materials or silver-containing materials, and a space is formed between any two adjacent ones of the conductive substrates without carbon-containing materials or silver-containing materials. The first electrode structure and the second electrode structure of the electrode assembly are electrically connected to the second portion of each of the conductive substrates and the outermost covering structure, respectively.

Therefore, in the stacked capacitor assembly and the stacked capacitor package structure provided by the present disclosure, by virtue of “the inner conductive structure being configured to cover the first portion of each of the conductive substrates and be disposed between any two adjacent ones of the conductive substrates,” “the outermost covering structure being configured to cover the inner conductive structure,” “the inner conductive structure being provided without carbon-containing materials or silver-containing materials,” and “the space being formed between any two adjacent ones of the conductive substrates without carbon-containing materials or silver-containing materials,” the stacked capacitor assembly provided by the present disclosure can not only be simplified in structure (without a carbon-containing material layer or a silver-containing materials layer), but also meet the capacitor characteristic requirements (or the electrical characteristics requirements). Thus, when the stacked capacitor assembly is applied to the stacked capacitor package structure, the stacked capacitor package structure can still achieve the capacitor characteristics and functions when simplifying the overall structure of the stacked capacitor assembly.

Furthermore, in the method of manufacturing the stacked capacitor assembly provided by the present disclosure, by virtue of “providing a plurality of conductive substrates each having a first portion and a second portion opposite to the first portion,” “arranging the conductive substrates to be spaced apart from each other,” “forming an inner conductive structure for covering the first portion of each of the conductive substrates and filling between any two adjacent ones of the conductive substrates,” “forming an outermost covering structure for covering the inner conductive structure,” “the inner conductive structure being provided without carbon-containing materials or silver-containing materials,” and “the space being formed between any two adjacent ones of the conductive substrates without carbon-containing materials or silver-containing materials,” the stacked capacitor assembly provided by the present disclosure can not only be simplified in structure (without a carbon-containing material layer or a silver-containing materials layer), but also meet the capacitor characteristic requirements (or the electrical characteristics requirements). Thus, when the stacked capacitor assembly is applied to the stacked capacitor package structure, the stacked capacitor package structure can still achieve the capacitor characteristics and functions when simplifying the overall structure of the stacked capacitor assembly.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for manufacturing a stacked capacitor assembly according to a first embodiment of the present disclosure;

FIG. 2 is a schematic cross-sectional view of step S100 and step S102 of the method of manufacturing the stacked capacitor assembly according to the first embodiment of the present disclosure;

FIG. 3 is a schematic cross-sectional view of step S104 of the method of manufacturing the stacked capacitor assembly according to the first embodiment of the present disclosure;

FIG. 4 is a schematic cross-sectional view of step S106 of the method of manufacturing the stacked capacitor assembly according to the first embodiment of the present disclosure;

FIG. 5 is a schematic cross-sectional view of a first stacked capacitor package structure provided by the first embodiment of the present disclosure;

FIG. 6 is a schematic cross-sectional view of a second stacked capacitor package structure provided by the first embodiment of the present disclosure;

FIG. 7 is a schematic cross-sectional view of a third stacked capacitor package structure provided by the first embodiment of the present disclosure;

FIG. 8 is a flowchart of a method for manufacturing a stacked capacitor assembly according to a second embodiment of the present disclosure;

FIG. 9 is a schematic cross-sectional view of step S200 and step S202 of the method of manufacturing the stacked capacitor assembly according to the second embodiment of the present disclosure;

FIG. 10 is a schematic cross-sectional view of step S204 of the method of manufacturing the stacked capacitor assembly according to the second embodiment of the present disclosure;

FIG. 11 is a schematic cross-sectional view of step S206 of the method of manufacturing the stacked capacitor assembly according to the second embodiment of the present disclosure;

FIG. 12 is a schematic cross-sectional view of a first stacked capacitor package structure provided by the second embodiment of the present disclosure;

FIG. 13 is a schematic cross-sectional view of a second stacked capacitor package structure provided by the second embodiment of the present disclosure;

FIG. 14 is a schematic cross-sectional view of a third stacked capacitor package structure provided by the second embodiment of the present disclosure;

FIG. 15 is a schematic cross-sectional view of a fourth stacked capacitor package structure provided by the second embodiment of the present disclosure; and

FIG. 16 is a schematic cross-sectional view of a fifth stacked capacitor package structure provided by the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

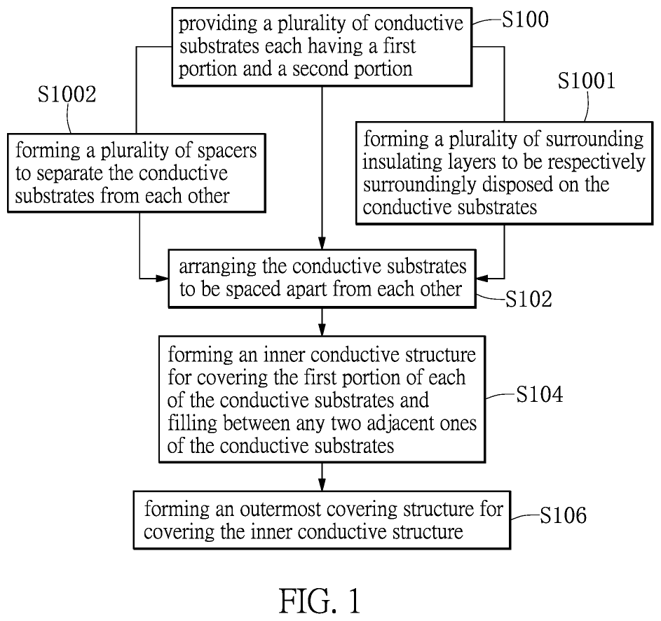

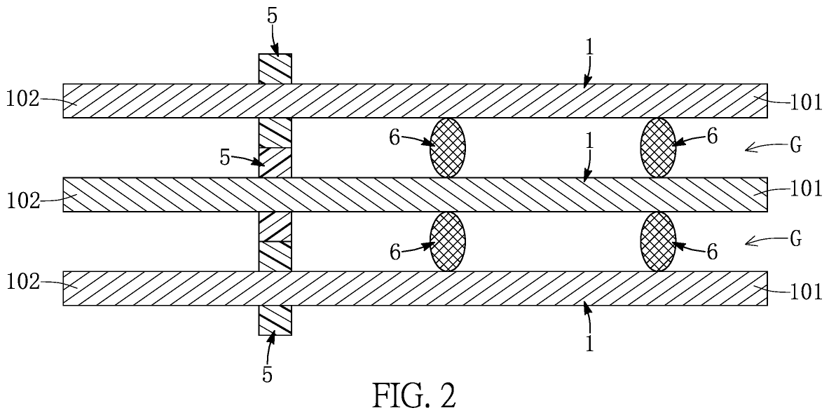

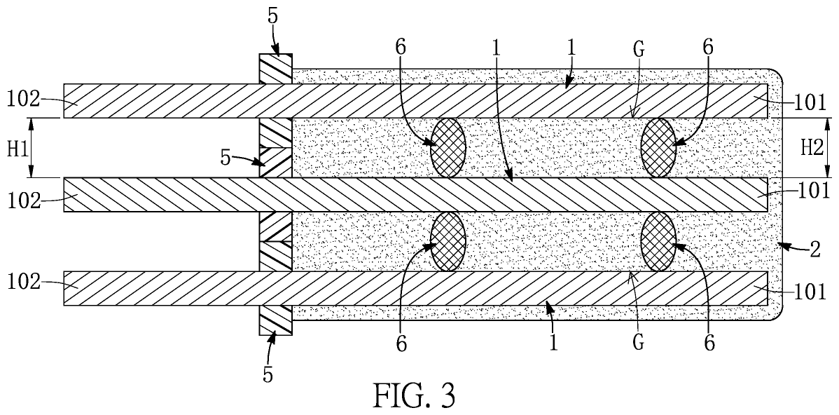

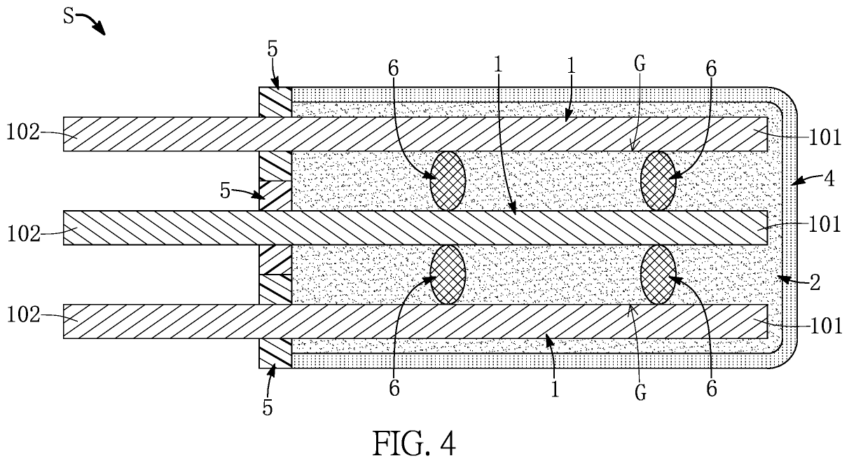

Referring to FIG. 1 to FIG. 4, a first embodiment of the present disclosure provides a method of manufacturing a stacked capacitor assembly S, which at least includes the following steps: firstly, referring to FIG. 1 and FIG. 2, providing a plurality of conductive substrates 1 (for example, FIG. 2 takes three conductive substrates 1 as an example, the three conductive substrates 1 as shown in FIG. 2 can be provided or manufactured separately, and in feasible embodiments, the surrounding insulating layers 5 and the spacers 6 as shown in FIG. 2 can be omitted, or one of the surrounding insulating layer 5 and the spacer 6 can be omitted), in which each of the conductive substrates 1 has a first portion 101 and a second portion 102 opposite to the first portion 101 (step S100); next, referring to FIG. 1 and FIG. 2, arranging the conductive substrates 1 in a predetermined direction (such as a vertical direction) to be spaced apart from each other (that is to say, the conductive substrates 1 can be spaced apart from each other) (step S102); then, referring to FIG. 1, FIG. 2 and FIG. 3, forming an inner conductive structure 2 (for example, by impregnating, dipping or any method for forming a conductive material) for covering (or enclosing) the first portion 101 of each of the conductive substrates 1 and filling between any two adjacent ones of the conductive substrates 1 (that is to say, a space G formed between each two adjacent conductive substrates 1 will be filled with the inner conductive structure 2) (step S104); and, referring to FIG. 1 and FIG. 4, forming an outermost covering structure 4 (for example, by impregnating, dipping or any method for forming a conductive material) for covering (or enclosing) the inner conductive structure 2 (step S106). It should be noted that the inner conductive structure 2 is provided without carbon-containing materials (such as a carbon glue material layer), silver-containing materials (such as a silver glue material layer) or any internal conductive material containing a carbon glue material or a silver glue material, so that a space G is formed between any two adjacent ones of the conductive substrates 1 without carbon-containing materials (such as carbon glue materials) or silver-containing materials (such as silver glue materials). However, the aforementioned details are disclosed for exemplary purposes only, and are not meant to limit the scope of the present disclosure.

For example, referring to FIG. 1 and FIG. 2, the step S100 of providing the conductive substrates 1 further includes forming a plurality of surrounding insulating layers 5 to be respectively surroundingly disposed on the conductive substrates 1 (for example, in feasible embodiments, the spacers 6 as shown in FIG. 2 may be omitted) (step S1001). More particularly, as shown in FIG. 2, each of the surrounding insulating layers 5 can be located between the first portion 101 and the second portion 102 of a corresponding one of the conductive substrates 1. Moreover, as shown in FIG. 2, in the step S102 of arranging the conductive substrates 1, the surrounding insulating layers 5 can be separate from each other or connected in sequence to form an insulating barrier structure (FIG. 2 illustrates an example using the surrounding insulating layers 5 connected in sequence to form an insulating barrier structure). In addition, as shown in FIG. 4, the inner conductive structure 2 and the outermost covering structure 4 are connected to the surrounding insulating layers 5, and the inner conductive structure 2 and the outermost covering structure 4 are separate from the second portions 102 of the conductive substrates 1 by the surrounding insulating layers 5 (that is to say, the inner conductive structure 2 and the outermost covering structure 4 are blocked by the surrounding insulating layers 5). However, the aforementioned details are disclosed for exemplary purposes only, and are not meant to limit the scope of the present disclosure.

For example, referring to FIG. 1 and FIG. 2, the step S100 of providing the conductive substrates 1 further includes forming a plurality of spacers 6 (such as support bodies) to separate the conductive substrates 1 from each other (for example, in feasible embodiments, the surrounding insulating layers 5 illustrated in FIG. 2 may be omitted) (S1002). More particularly, as shown in FIG. 2, each spacer 6 can be connected between any two adjacent conductive substrates 1 (that is to say, at least one spacer 6 can be disposed between every two adjacent conductive substrates 1) to form a gap space G between any two adjacent conductive substrates 1. Moreover, referring to FIG. 2 and FIG. 3, any two adjacent ones of the conductive substrates 1 are separated from each other through at least one of the spacers 6, so that the space G formed between any two adjacent ones of the conductive substrates 1 can be filled with the inner conductive structure 2 (for example, the gap spacer G can be completely or partially filled by the inner conductive structure 2). In addition, as shown in FIG. 3, each of the spacers 6 can be a conductive spacer or an insulating spacer, and a thickness H1 of a part of the inner conductive structure 2 (or a thickness H1 of a part of the surrounding insulating layer 5) located between any two adjacent ones of the conductive substrates 1 may be equal to or substantially equal to a thickness H2 of the spacer 6. However, the aforementioned details are disclosed for exemplary purposes only, and are not meant to limit the scope of the present disclosure.

Moreover, as shown in FIG. 4, through the method of manufacturing the stacked capacitor assembly S provided in the first embodiment of the present disclosure, the first embodiment of the present disclosure further provides a stacked capacitor assembly S, which includes a plurality of conductive substrates 1, an inner conductive structure 2 and an outermost covering structure 4. More particularly, each of the conductive substrates 1 has a first portion 101 (or a first substrate part) and a second portion 102 (or a second substrate part) opposite to the first portion 101. The inner conductive structure 2 is configured to cover or enclose the first portion 101 of each of the conductive substrates 1 and be disposed (such as be filled) between any two adjacent ones of the conductive substrates 1. The outermost covering structure 4 is configured to cover or enclose the inner conductive structure 2. It should be noted that the inner conductive structure 2 is provided without carbon-containing materials, silver-containing materials or any internal conductive material containing a carbon glue material or a silver glue material, so that a space G is formed between any two adjacent ones of the conductive substrates 1 without carbon-containing materials or silver-containing materials.

For example, as shown in FIG. 4, the stacked capacitor assembly S provided by the present disclosure further includes a plurality of surrounding insulating layers 5, and the surrounding insulating layers 5 can be configured to be respectively surroundingly disposed on the conductive substrates 1. Moreover, the stacked capacitor assembly S provided by the present disclosure further includes a plurality of spacers 6, and each of the spacers 6 is connected between any two adjacent ones of the conductive substrates 1 to form a space G between any two adjacent ones of the conductive substrates 1. It should be noted that in a feasible embodiment, the surrounding insulating layers 5 and the spacers 6 illustrated in FIG. 4 can be omitted, or the surrounding insulating layers 5 or the spacers 6 can be omitted in FIG. 4. However, the aforementioned details are disclosed for exemplary purposes only, and are not meant to limit the scope of the present disclosure.

For example, as shown in FIG. 4, each of the conductive substrates 1 can be a metal foil having an oxide layer formed on a surface thereof, the inner conductive structure 2 can be a conductive polymer layer without containing carbon glue and silver glue, and the outermost covering structure 4 may include at least one of a single carbon glue layer (not shown) and a single silver glue layer (not shown) (that is to say, the outermost covering structure 4 can be a single carbon glue layer, a single silver glue layer, or can include both the single carbon glue layer and the single silver glue layer). In addition, when the outermost covering structure 4 includes both the single carbon glue layer and the single silver glue layer, the single carbon glue layer of the outermost covering structure 4 is allowable to be configured to cover or enclose the inner conductive structure 2, and the single silver glue layer of the outermost covering structure 4 is allowable to be configured to cover or enclose the single carbon glue layer. However, the aforementioned details are disclosed for exemplary purposes only, and are not meant to limit the scope of the present disclosure.

Furthermore, referring to FIG. 4 to FIG. 6, when the stacked capacitor assembly S provided by the first embodiment of the present disclosure is applied to a stacked capacitor package structure M, the stacked capacitor package structure M provided by the first embodiment of the present disclosure includes a stacked capacitor assembly S, an electrode assembly E and an insulating package body B. More particularly, the stacked capacitor assembly S includes a plurality of conductive substrates 1, an inner conductive structure 2 and an outermost covering structure 4, each of the conductive substrates 1 has a first portion 101 and a second portion 102 opposite to the first portion 101, the inner conductive structure 2 can be configured to cover or enclose the first portion 101 of each of the conductive substrates 1 and be disposed (such as filled) between any two adjacent ones of the conductive substrates 1, and the outermost covering structure 4 can be configured to cover or enclose the inner conductive structure 2. The electrode assembly E includes a first electrode structure 7 and a second electrode structure 8 respectively electrically connected to the stacked capacitor assembly S, and the first electrode structure 7 and the second electrode structure 8 of the electrode assembly E can be electrically connected to the second portion 102 of each of the conductive substrates 1 and the outermost covering structure 4, respectively. The insulating package body B can be configured to cover or enclose the stacked capacitor assembly S and carry the electrode assembly E.

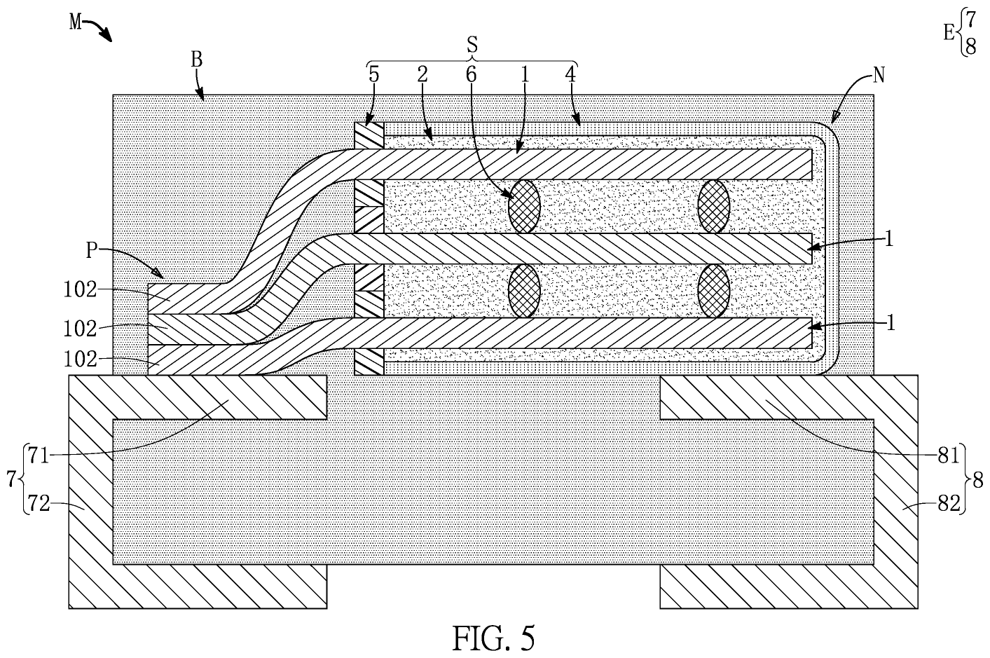

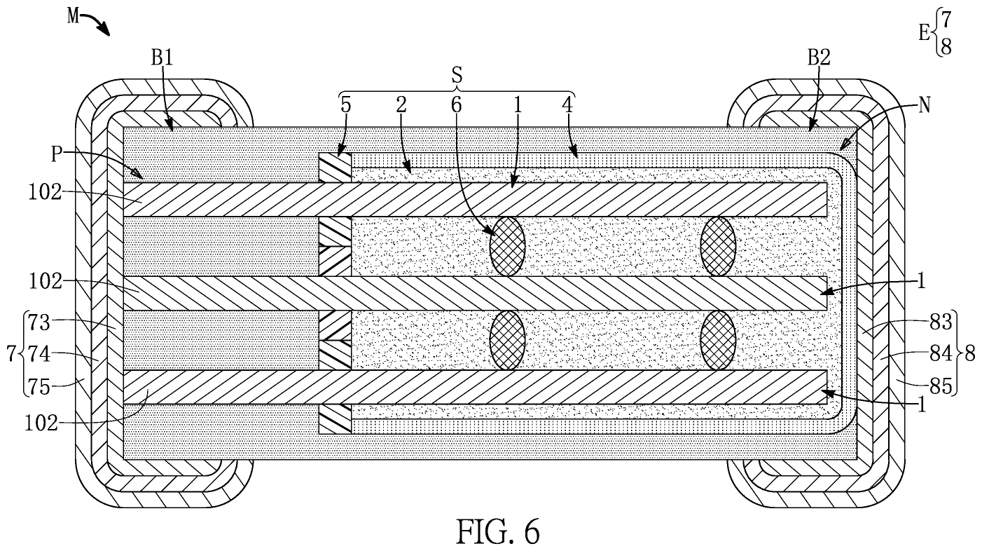

For example, referring to FIG. 5 and FIG. 6, the electrode assembly E can be a conductive pin assembly (as shown in FIG. 5) or a terminal electrode assembly (as shown in FIG. 6). Moreover, the second portions 102 of the conductive substrates 1 can cooperate with each other (such as can be electrically connected with each other by soldering) to form a positive electrode portion P of the stacked capacitor assembly S, and the outermost covering structure 4 can be configured to serve as a negative electrode portion N of the stacked capacitor assembly S. Therefore, the first electrode structure 7 and the second electrode structure 8 of the electrode assembly E can be electrically connected to the positive electrode portion P and the negative electrode portion N of the stacked capacitor assembly S, respectively. It should be noted that in a feasible embodiment, the surrounding insulating layers 5 and the spacers 6 illustrated in FIG. 5 and FIG. 6 can be omitted, or the surrounding insulating layers 5 or the spacers 6 can be omitted in FIG. 5 and FIG. 6. However, the aforementioned details are disclosed for exemplary purposes only, and are not meant to limit the scope of the present disclosure.

For example, referring to FIG. 4 and FIG. 5, when the electrode assembly E is the conductive pin assembly (or when the stacked capacitor package structure M is a pin-type capacitor), the first electrode structure 7 of the electrode assembly E includes a first embedded portion 71 covered or enclosed by the insulating package body B and a first exposed portion 72 connected to the first embedded portion 71 and exposed from the insulating package body B, and the second electrode structure 8 of the electrode assembly E includes a second embedded portion 81 covered or enclosed by the insulating package body B and a second exposed portion 82 connected to the second embedded portion 81 and exposed from the insulating package body B. More particularly, the first embedded portion 71 of the first electrode structure 7 is electrically connected to the positive electrode portion P of the stacked capacitor assembly S, and the first exposed portion 72 of the first electrode structure 7 can extend along an outer surface of the insulating package body B (for example, extending from a lateral side to a bottom side of the insulating package body B). In addition, the second embedded portion 81 of the second electrode structure 8 is electrically connected to the negative electrode portion N of the stacked capacitor assembly S, and the second exposed portion 82 of the second electrode structure 8 can extend along the outer surface of the insulating package body B (for example, extending from another lateral side to the bottom side of the insulating package body B). However, the aforementioned details are disclosed for exemplary purposes only, and are not meant to limit the scope of the present disclosure.

For example, referring to FIG. 4 and FIG. 6, when the electrode assembly E is the terminal electrode assembly (or when the stacked capacitor package structure M is a terminal electrode capacitor), the first electrode structure 7 of the electrode assembly E includes a first inner conductive layer 73 configured to cover or enclose a first side portion B1 of the insulating package body B and electrically contact the positive electrode portion P of the stacked capacitor assembly S (or electrically contact the second portions 102 of the conductive substrates 1), a first intermediate conductive layer 74 configured to cover or enclose the first inner conductive layer 73, and a first outer conductive layer 75 configured to cover or enclose the first intermediate conductive layer 74, and the second electrode structure 8 of the electrode assembly E includes a second inner conductive layer 83 configured to cover or enclose a second side portion B2 of the insulating package body B and electrically contact the negative electrode portion N of the stacked capacitor assembly S (or electrically contact the outermost covering structure 4), a second intermediate conductive layer 84 configured to cover or enclose the second inner conductive layer 83, and a second outer conductive layer 85 configured to cover or enclose the second intermediate conductive layer 84. More particularly, the first inner conductive layer 73 can be one of a silver-containing materials layer (such as an Ag layer) and a copper-containing material layer (such as a Cu layer), the first intermediate conductive layer 74 can be a nickel-containing material layer (such as a Ni layer), and the first outer conductive layer 75 is a tin-containing material layer (such as a Sn layer). In addition, the second inner conductive layer 83 can be one of a silver-containing materials layer (such as an Ag layer) and a copper-containing material layer (such as a Cu layer), the second intermediate conductive layer 84 can be a nickel-containing material layer (such as a Ni layer), and the second outer conductive layer 85 can be a tin-containing material layer (such as a Sn layer). However, the aforementioned details are disclosed for exemplary purposes only, and are not meant to limit the scope of the present disclosure.

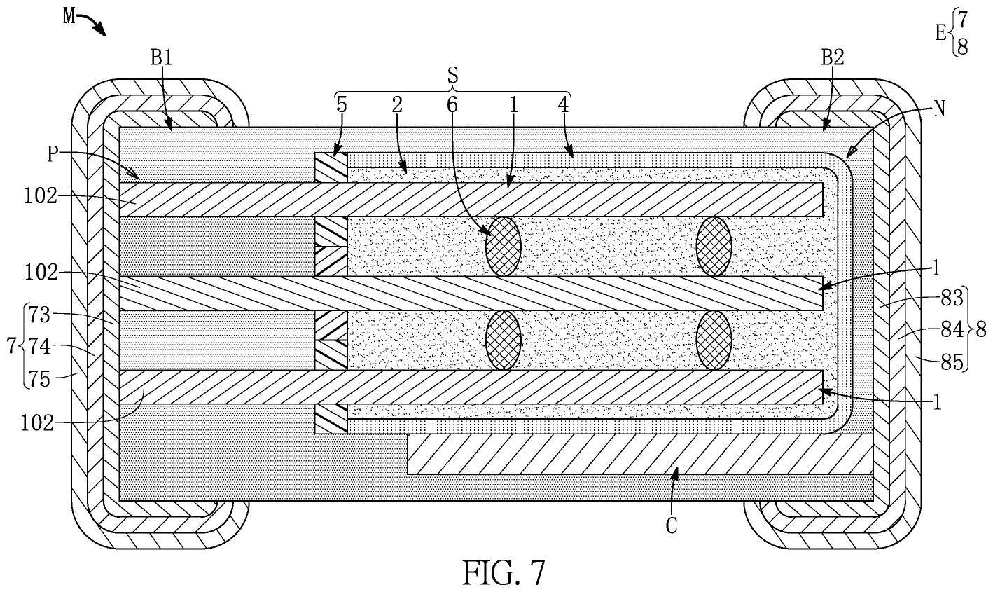

It should be noted that as shown in FIG. 7, the stacked capacitor assembly S can further be supported or carried by a conductive carrier substrate C, and the negative electrode portion N of the stacked capacitor assembly S can be electrically connected to the second electrode structure 8 of the electrode assembly E through the conductive carrier substrate C (that is to say, the negative electrode portion N of the stacked capacitor assembly S does not directly and electrically contact the second electrode structure 8 of the electrode assembly E).

### Second Embodiment

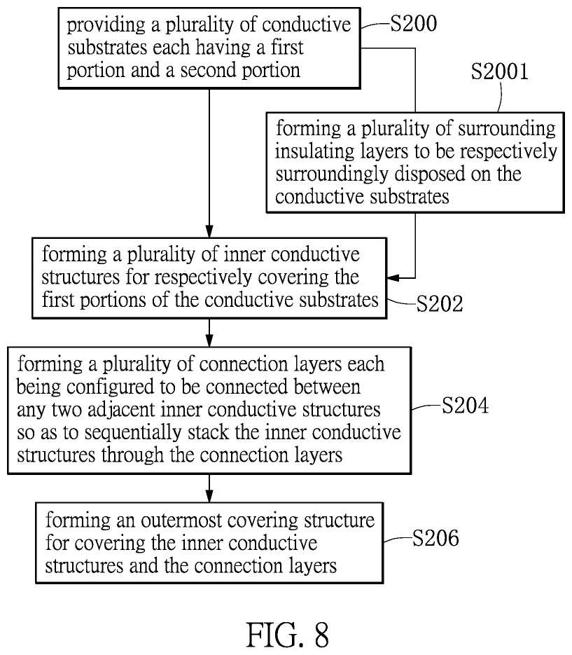

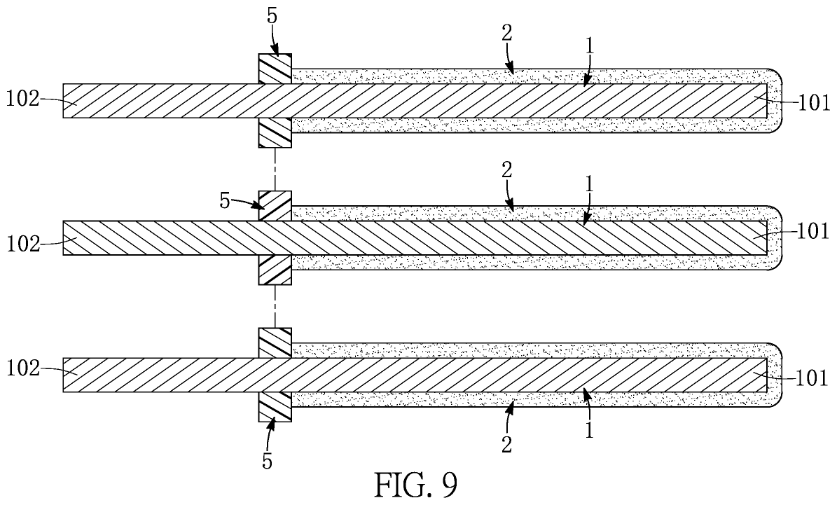

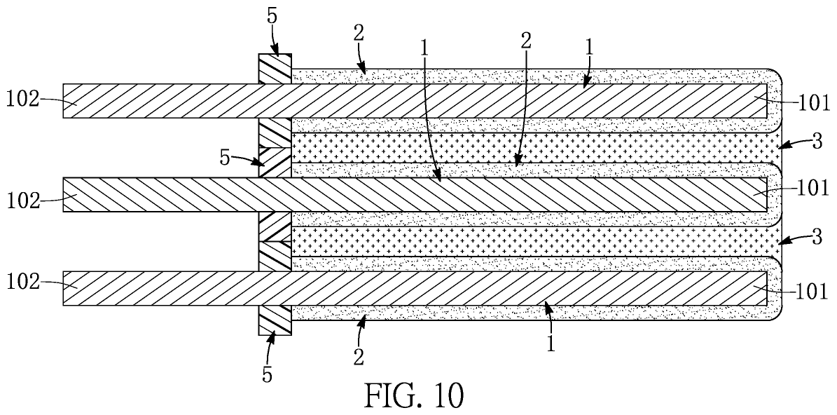

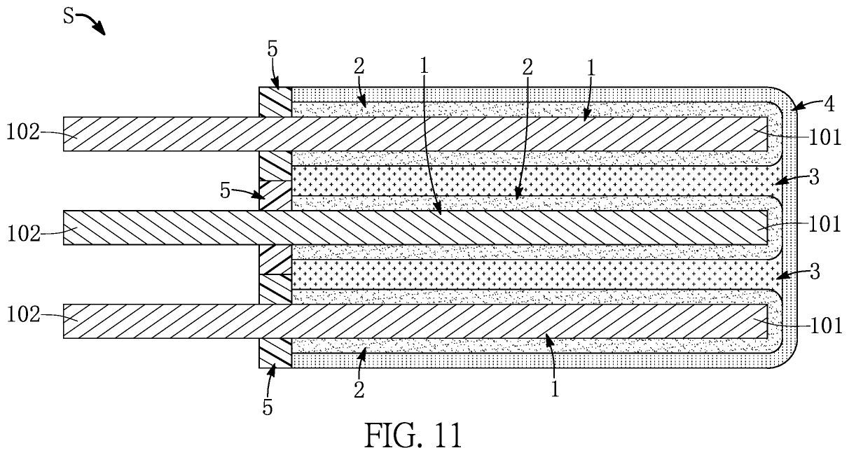

Referring to FIG. 8 to FIG. 11, a second embodiment of the present disclosure provides a method of manufacturing a stacked capacitor assembly S, which at least includes the following steps: firstly, referring to FIG. 8 and FIG. 9, providing a plurality of conductive substrates 1 (for example, FIG. 9 takes three conductive substrates 1 as an example, the three conductive substrates 1 as shown in FIG. 9 can be provided or manufactured separately, and in feasible embodiments, the surrounding insulating layers 5 as shown in FIG. 9 can be omitted), in which each of the conductive substrates 1 has a first portion 101 and a second portion 102 opposite to the first portion 101 (step S200); next, referring to FIG. 8 and FIG. 9, forming a plurality of inner conductive structures 2 (for example, by impregnating, dipping or any method for forming a conductive material) for respectively covering (or enclosing) the first portions 101 of the conductive substrates 1 (step S202); then, referring to FIG. 8 and FIG. 10, forming a plurality of connection layers 3 (for example, by spraying, coating, printing or any method that can form conductive materials), in which each connection layer 3 is configured to be connected between any two adjacent inner conductive structures 2 so as to sequentially stack the inner conductive structures 2 through the connection layers 3 (step S204); and, referring to FIG. 8 and FIG. 11, forming an outermost covering structure 4 (for example, by impregnating, dipping or any method for forming a conductive material) for covering (or enclosing) the inner conductive structures 2 and the connection layers 3 (step S206). It should be noted that each inner conductive structure 2 is provided without silver-containing materials (such as a silver glue material layer) or any internal conductive material containing a carbon glue material or a silver glue material, so that a space G is formed between any two adjacent ones of the conductive substrates 1 without silver-containing materials (such as silver glue materials). It should be noted that the steps S200 and S202 can be integrated into the step of providing the conductive substrates 1 each having the inner conductive structure 2 that is pre-formed (or the step of providing the conductive substrates 1 each preformed with the inner conductive structure 2). However, the aforementioned details are disclosed for exemplary purposes only, and are not meant to limit the scope of the present disclosure.

For example, referring to FIG. 8 and FIG. 9, the step S200 of providing the conductive substrates 1 further includes forming a plurality of surrounding insulating layers 5 to be respectively surroundingly disposed on the conductive substrates 1 (step S2001). More particularly, as shown in FIG. 9, each of the surrounding insulating layers 5 can be located between the first portion 101 and the second portion 102 of a corresponding one of the conductive substrates 1. Moreover, as shown in FIG. 11, in the step S204 of forming the connection layers 3, the surrounding insulating layers 5 can be separate from each other or connected in sequence to form an insulating barrier structure (FIG. 11 illustrates an example using the surrounding insulating layers 5 connected in sequence to form an insulating barrier structure). In addition, as shown in FIG. 11, the inner conductive structures 2 and the outermost covering structure 4 are connected to the surrounding insulating layers 5, and the inner conductive structure 2 and the outermost covering structure 4 are separate from the second portions 102 of the conductive substrates 1 by the surrounding insulating layers 5 (that is to say, the inner conductive structure 2 and the outermost covering structure 4 are blocked by the surrounding insulating layers 5). It should be noted that when the surrounding insulating layers 5 are separate from each other, each connection layer 3 can be configured to be connected between any two adjacent surrounding insulating layers 5, so that the surrounding insulating layers 5 can be stacked sequentially through the connection layers 3. However, the aforementioned details are disclosed for exemplary purposes only, and are not meant to limit the scope of the present disclosure.

Moreover, as shown in FIG. 11, through the method of manufacturing the stacked capacitor assembly S provided in the second embodiment of the present disclosure, the second embodiment of the present disclosure further provides a stacked capacitor assembly S, which includes a plurality of conductive substrates 1, a plurality of inner conductive structures 2, a plurality of connection layers 3 and an outermost covering structure 4. More particularly, each of the conductive substrates 1 has a first portion 101 (or a first substrate part) and a second portion 102 (or a second substrate part) opposite to the first portion 101. The inner conductive structures 2 are configured to respectively cover or enclose the first portions 101 of the conductive substrates 1. Each connection layer 3 is configured to be connected between any two adjacent inner conductive structures 2, so that the inner conductive structures 2 can be sequentially stacked through the connection layers 3. The outermost covering structure 4 is configured to cover or enclose the inner conductive structures 2 and the connection layers 3. It should be noted that each inner conductive structure 2 is provided without silver-containing materials or any internal conductive material containing a carbon glue material or a silver glue material, so that a space G is formed between any two adjacent ones of the conductive substrates 1 without silver-containing materials.

For example, as shown in FIG. 11, the stacked capacitor assembly S provided by the present disclosure further includes a plurality of surrounding insulating layers 5, and the surrounding insulating layers 5 can be configured to be respectively surroundingly disposed on the conductive substrates 1. It should be noted that in a feasible embodiment, the surrounding insulating layers 5 illustrated in FIG. 11 can be omitted. However, the aforementioned details are disclosed for exemplary purposes only, and are not meant to limit the scope of the present disclosure.

For example, as shown in FIG. 11, each of the conductive substrates 1 can be a metal foil having an oxide layer formed on a surface thereof, the inner conductive structure 2 can be a conductive polymer layer without containing carbon glue and silver glue, each connection layer 3 (such as a conductive connection layer or an insulating connection layer) can be a polymer material layer, a carbon glue layer or an insulating glue layer (such as silicone or epoxy) (or that is to say, each connection layer 3 cannot be a silver glue layer), and the outermost covering structure 4 may include at least one of a single carbon glue layer (not shown) and a single silver glue layer (not shown) (that is to say, the outermost covering structure 4 can be a single carbon glue layer, a single silver glue layer, or can include both the single carbon glue layer and the single silver glue layer). In addition, when the outermost covering structure 4 includes both the single carbon glue layer and the single silver glue layer, the single carbon glue layer of the outermost covering structure 4 is allowable to be configured to cover or enclose the inner conductive structure 2, and the single silver glue layer of the outermost covering structure 4 is allowable to be configured to cover or enclose the single carbon glue layer. However, the aforementioned details are disclosed for exemplary purposes only, and are not meant to limit the scope of the present disclosure.

Furthermore, referring to FIG. 11 to FIG. 13, when the stacked capacitor assembly S provided by the second embodiment of the present disclosure is applied to a stacked capacitor package structure M, the stacked capacitor package structure M provided by the second embodiment of the present disclosure includes a stacked capacitor assembly S, an electrode assembly E and an insulating package body B. More particularly, the stacked capacitor assembly S includes a plurality of conductive substrates 1, a plurality of inner conductive structures 2, a plurality of connection layers 3 and an outermost covering structure 4. Each of the conductive substrates 1 has a first portion 101 and a second portion 102 opposite to the first portion 101, the inner conductive structures 2 can be configured to respectively cover or enclose the first portions 101 of the conductive substrates 1, each connection layer 3 is configured to be connected between any two adjacent inner conductive structures 2 so as to sequentially stack the inner conductive structures 2 through the connection layers 3, and the outermost covering structure 4 can be configured to cover or enclose the inner conductive structures 2 and the connection layers 3. The electrode assembly E includes a first electrode structure 7 and a second electrode structure 8 respectively electrically connected to the stacked capacitor assembly S, and the first electrode structure 7 and the second electrode structure 8 of the electrode assembly E can be electrically connected to the second portion 102 of each of the conductive substrates 1 and the outermost covering structure 4, respectively. The insulating package body B can be configured to cover or enclose the stacked capacitor assembly S and carry the electrode assembly E.

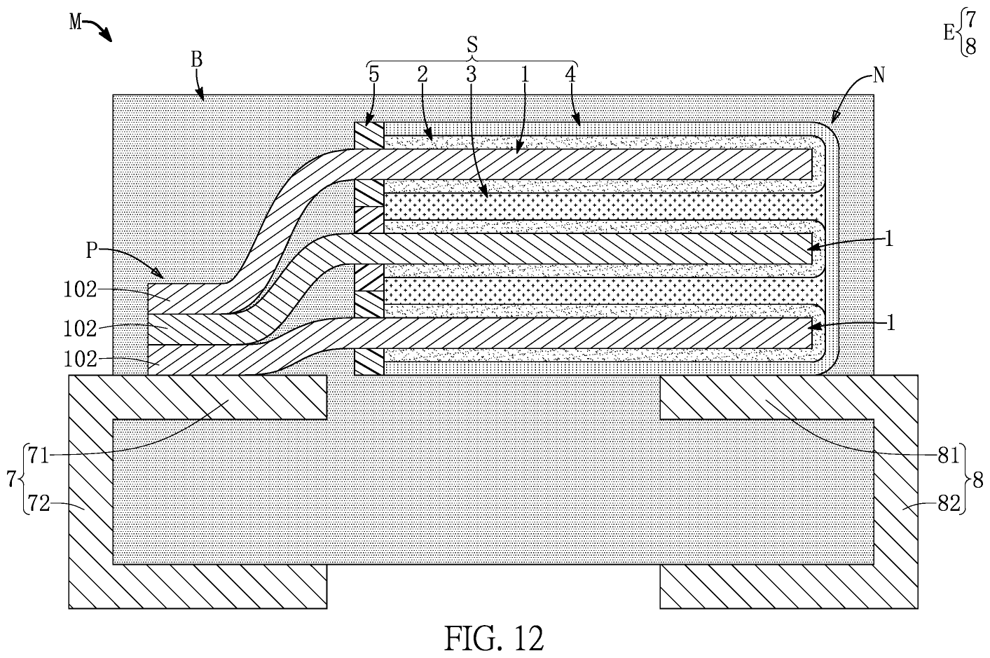

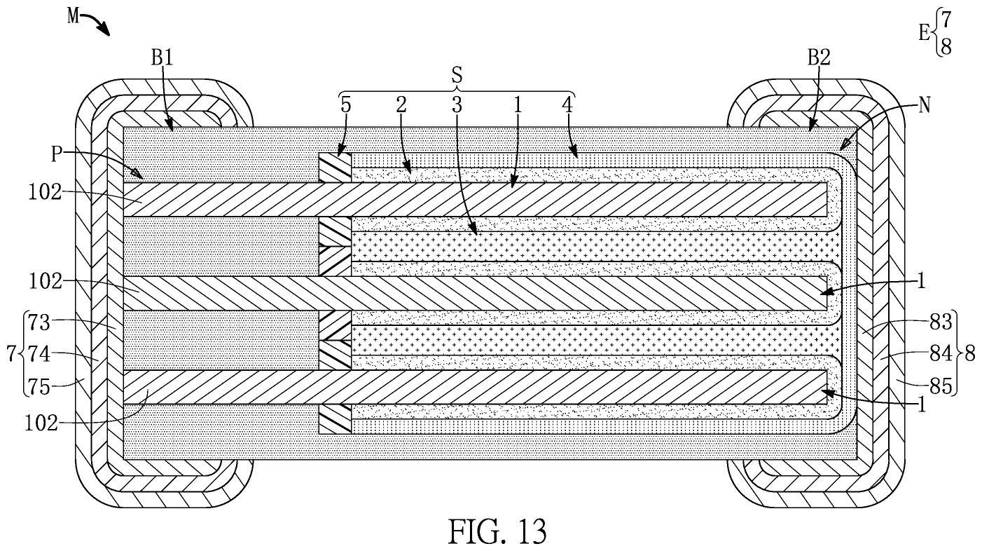

For example, referring to FIG. 12 and FIG. 13, the electrode assembly E can be a conductive pin assembly (as shown in FIG. 12) or a terminal electrode assembly (as shown in FIG. 13). Moreover, the second portions 102 of the conductive substrates 1 can cooperate with each other (such as can be electrically connected with each other by soldering) to form a positive electrode portion P of the stacked capacitor assembly S, and the outermost covering structure 4 can be configured to serve as a negative electrode portion N of the stacked capacitor assembly S. Therefore, the first electrode structure 7 and the second electrode structure 8 of the electrode assembly E can be electrically connected to the positive electrode portion P and the negative electrode portion N of the stacked capacitor assembly S, respectively. It should be noted that in a feasible embodiment, the surrounding insulating layers 5 illustrated in FIG. 12 and FIG. 13 can be omitted. However, the aforementioned details are disclosed for exemplary purposes only, and are not meant to limit the scope of the present disclosure.

For example, referring to FIG. 11 and FIG. 12, when the electrode assembly E is the conductive pin assembly (or when the stacked capacitor package structure M is a pin-type capacitor), the first electrode structure 7 of the electrode assembly E includes a first embedded portion 71 covered or enclosed by the insulating package body B and a first exposed portion 72 connected to the first embedded portion 71 and exposed from the insulating package body B, and the second electrode structure 8 of the electrode assembly E includes a second embedded portion 81 covered or enclosed by the insulating package body B and a second exposed portion 82 connected to the second embedded portion 81 and exposed from the insulating package body B. More particularly, the first embedded portion 71 of the first electrode structure 7 is electrically connected to the positive electrode portion P of the stacked capacitor assembly S, and the first exposed portion 72 of the first electrode structure 7 can extend along an outer surface of the insulating package body B (for example, extending from a lateral side to a bottom side of the insulating package body B). In addition, the second embedded portion 81 of the second electrode structure 8 is electrically connected to the negative electrode portion N of the stacked capacitor assembly S, and the second exposed portion 82 of the second electrode structure 8 can extend along the outer surface of the insulating package body B (for example, extending from another lateral side to the bottom side of the insulating package body B). However, the aforementioned details are disclosed for exemplary purposes only, and are not meant to limit the scope of the present disclosure.

For example, referring to FIG. 11 and FIG. 13, when the electrode assembly E is the terminal electrode assembly (or when the stacked capacitor package structure M is a terminal electrode capacitor), the first electrode structure 7 of the electrode assembly E includes a first inner conductive layer 73 configured to cover or enclose a first side portion B1 of the insulating package body B and electrically contact the positive electrode portion P of the stacked capacitor assembly S (or electrically contact the second portions 102 of the conductive substrates 1), a first intermediate conductive layer 74 configured to cover or enclose the first inner conductive layer 73, and a first outer conductive layer 75 configured to cover or enclose the first intermediate conductive layer 74, and the second electrode structure 8 of the electrode assembly E includes a second inner conductive layer 83 configured to cover or enclose a second side portion B2 of the insulating package body B and electrically contact the negative electrode portion N of the stacked capacitor assembly S (or electrically contact the outermost covering structure 4), a second intermediate conductive layer 84 configured to cover or enclose the second inner conductive layer 83, and a second outer conductive layer 85 configured to cover or enclose the second intermediate conductive layer 84. More particularly, the first inner conductive layer 73 can be one of a silver-containing materials layer (such as an Ag layer) and a copper-containing material layer (such as a Cu layer), the first intermediate conductive layer 74 can be a nickel-containing material layer (such as a Ni layer), and the first outer conductive layer 75 is a tin-containing material layer (such as a Sn layer). In addition, the second inner conductive layer 83 can be one of a silver-containing materials layer (such as an Ag layer) and a copper-containing material layer (such as a Cu layer), the second intermediate conductive layer 84 can be a nickel-containing material layer (such as a Ni layer), and the second outer conductive layer 85 can be a tin-containing material layer (such as a Sn layer). However, the aforementioned details are disclosed for exemplary purposes only, and are not meant to limit the scope of the present disclosure.

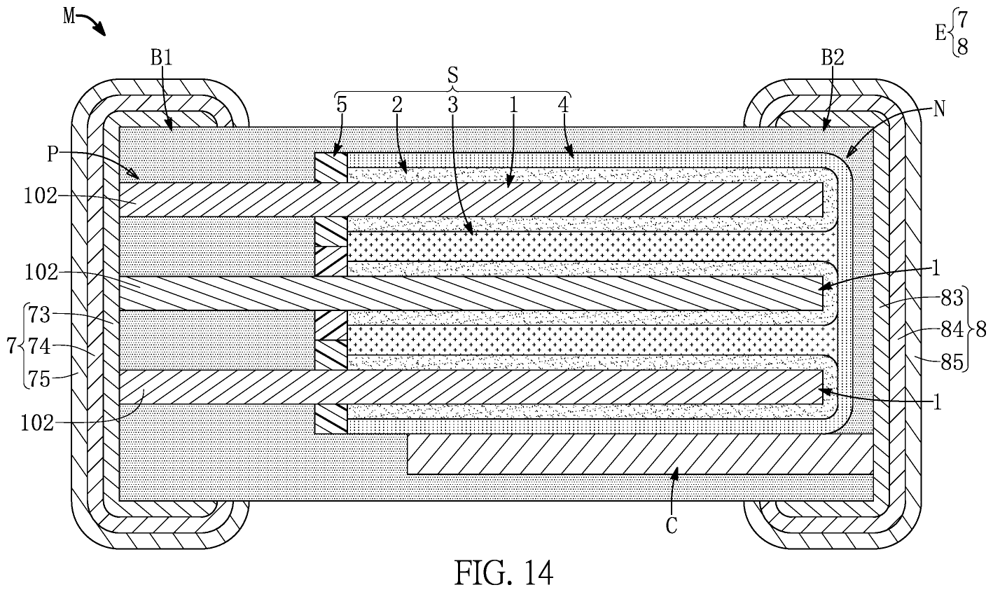

It should be noted that as shown in FIG. 14, the stacked capacitor assembly S can further be supported or carried by a conductive carrier substrate C, and the negative electrode portion N of the stacked capacitor assembly S can be electrically connected to the second electrode structure 8 of the electrode assembly E through the conductive carrier substrate C (that is to say, the negative electrode portion N of the stacked capacitor assembly S does not directly and electrically contact the second electrode structure 8 of the electrode assembly E).

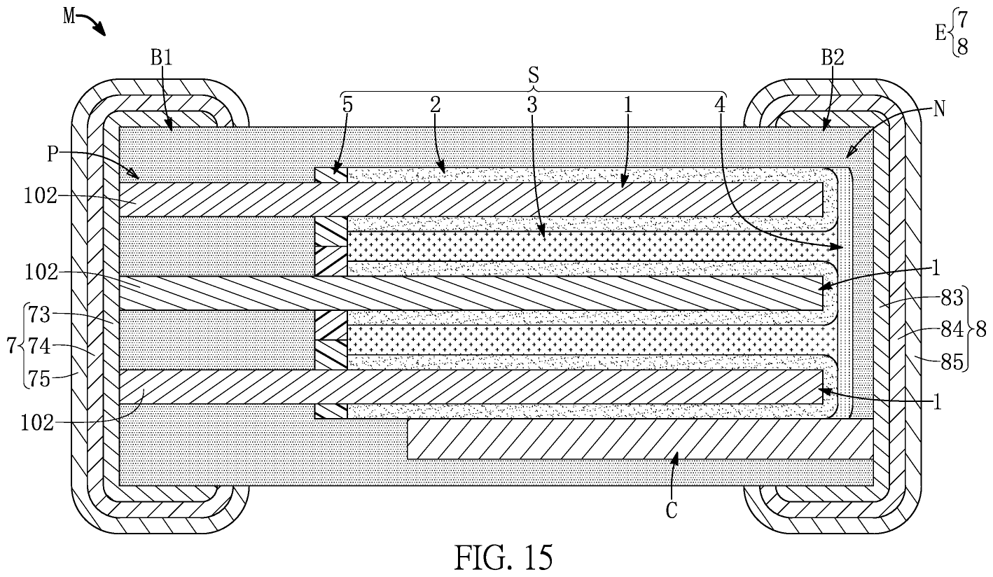

It should be noted that as shown in FIG. 15, the outermost covering structure 4 is disposed on one side of each inner conductive structure 2 and is separate from the surrounding insulating layers 5, thereby forming a vertical conductive structure. That is to say, the upper surface of the uppermost inner conductive structure 2 and the lower surface of the lowermost inner conductive structure 2 are not covered by the outermost covering structure 4.

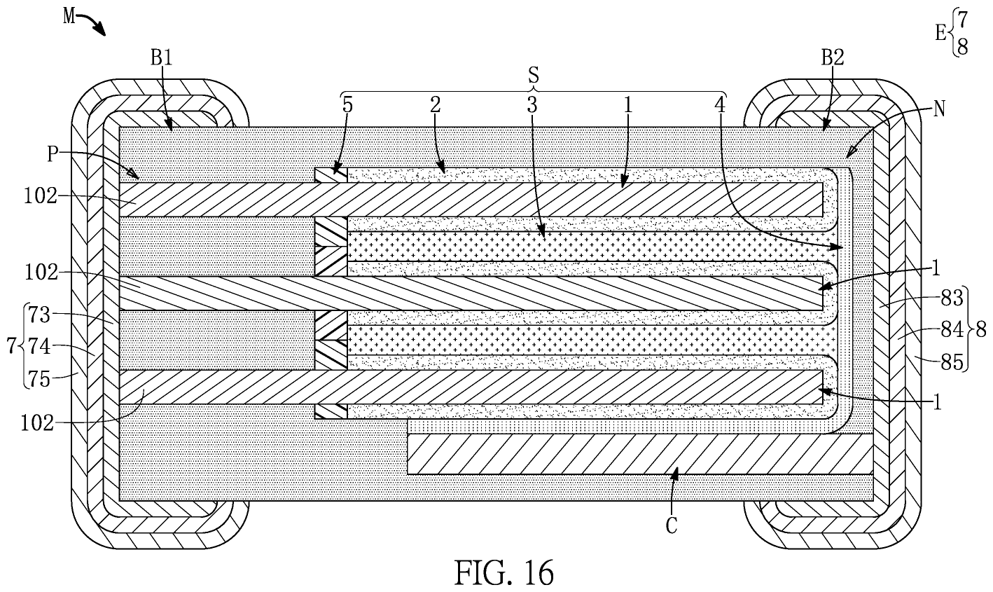

It should be noted that as shown in FIG. 16, the outermost covering structure 4 is disposed on one side of each inner conductive structure 2 and is separate from the surrounding insulating layers 5, thereby forming an L-shaped conductive structure. That is to say, a portion of the lower surface of the lowermost inner conductive structure 2 is covered by the outermost covering structure 4, but the upper surface of the uppermost inner conductive structure 2 is not covered by the outermost covering structure 4.

### Beneficial Effects of the Embodiments

In conclusion, in the stacked capacitor assembly S and the stacked capacitor package structure M provided by the present disclosure, by virtue of “the inner conductive structure 2 being configured to cover the first portion 101 of each of the conductive substrates 1 and be disposed between any two adjacent ones of the conductive substrates 1,” “the outermost covering structure 4 being configured to cover the inner conductive structure 2,” “the inner conductive structure 2 being provided without carbon-containing materials or silver-containing materials,” and “the space G being formed between any two adjacent ones of the conductive substrates 1 without carbon-containing materials or silver-containing materials,” the stacked capacitor assembly S provided by the present disclosure can not only be simplified in structure (without a carbon-containing material layer or a silver-containing materials layer), but also meet the capacitor characteristic requirements (or the electrical characteristics requirements). Thus, when the stacked capacitor assembly S is applied to the stacked capacitor package structure M, the stacked capacitor package structure M can still achieve the capacitor characteristics and functions when simplifying the overall structure of the stacked capacitor assembly S.

Furthermore, in the method of manufacturing the stacked capacitor assembly S provided by the present disclosure, by virtue of “providing a plurality of conductive substrates 1 each having a first portion 101 and a second portion 102 opposite to the first portion 101,” “arranging the conductive substrates 1 to be spaced apart from each other,” “forming an inner conductive structure 2 for covering the first portion 101 of each of the conductive substrates 1 and filling between any two adjacent ones of the conductive substrates 1,” “forming an outermost covering structure 4 for covering the inner conductive structure 2,” “the inner conductive structure 2 being provided without carbon-containing materials or silver-containing materials,” and “the space G being formed between any two adjacent ones of the conductive substrates 1 without carbon-containing materials or silver-containing materials,” the stacked capacitor assembly S provided by the present disclosure can not only be simplified in structure (without a carbon-containing material layer or a silver-containing materials layer), but also meet the capacitor characteristic requirements (or the electrical characteristics requirements). Thus, when the stacked capacitor assembly S is applied to the stacked capacitor package structure M, the stacked capacitor package structure M can still achieve the capacitor characteristics and functions when simplifying the overall structure of the stacked capacitor assembly S.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A stacked capacitor assembly, comprising:
a plurality of conductive substrates, wherein each of the conductive substrates has a first portion and a second portion opposite to the first portion;
an inner conductive structure configured to cover the first portion of each of the conductive substrates and be disposed between any two adjacent ones of the conductive substrates; and
an outermost covering structure configured to cover the inner conductive structure;
wherein the inner conductive structure is provided without carbon-containing materials or silver-containing materials;
wherein a space is formed between any two adjacent ones of the conductive substrates without carbon-containing materials or silver-containing materials.

2. The stacked capacitor assembly according to claim 1,
wherein each of the conductive substrates is a metal foil having an oxide layer formed on a surface thereof, the inner conductive structure is a conductive polymer layer without containing carbon glue and silver glue, and the outermost covering structure includes at least one of a single carbon glue layer and a single silver glue layer;
wherein, when the outermost covering structure includes both the single carbon glue layer and the single silver glue layer, the single carbon glue layer of the outermost covering structure is allowable to be configured to cover the inner conductive structure, and the single silver glue layer of the outermost covering structure is allowable to be configured to cover the single carbon glue layer;
wherein the stacked capacitor assembly further includes a plurality of surrounding insulating layers, the surrounding insulating layers are configured to be respectively surroundingly disposed on the conductive substrates, and each of the surrounding insulating layers is located between the first portion and the second portion of a corresponding one of the conductive substrates;
wherein the surrounding insulating layers are separate from each other or connected in sequence to form an insulating barrier structure;
wherein the inner conductive structure and the outermost covering structure are connected to the surrounding insulating layers, and the inner conductive structure and the outermost covering structure are separate from the second portions of the conductive substrates by the surrounding insulating layers;
wherein the second portions of the conductive substrates cooperate with each other to form a positive electrode portion of the stacked capacitor assembly, and the outermost covering structure is configured to serve as a negative electrode portion of the stacked capacitor assembly.

3. The stacked capacitor assembly according to claim 1,
wherein each of the conductive substrates is a metal foil having an oxide layer formed on a surface thereof, the inner conductive structure is a conductive polymer layer without containing carbon glue and silver glue, and the outermost covering structure includes at least one of a single carbon glue layer and a single silver glue layer;
wherein, when the outermost covering structure includes both the single carbon glue layer and the single silver glue layer, the single carbon glue layer of the outermost covering structure is allowable to be configured to cover the inner conductive structure, and the single silver glue layer of the outermost covering structure is allowable to be configured to cover the single carbon glue layer;
wherein the stacked capacitor assembly further includes a plurality of spacers, and each of the spacers is connected between any two adjacent ones of the conductive substrates to form a space between any two adjacent ones of the conductive substrates;
wherein any two adjacent ones of the conductive substrates are separated from each other through at least one of the spacers, so that the space formed between any two adjacent ones of the conductive substrates is filled with the inner conductive structure;
wherein each of the spacers is a conductive spacer or an insulating spacer, and a thickness of a part of the inner conductive structure located between any two adjacent ones of the conductive substrates is equal to a thickness of the spacer;
wherein the second portions of the conductive substrates cooperate with each other to form a positive electrode portion of the stacked capacitor assembly, and the outermost covering structure is configured to serve as a negative electrode portion of the stacked capacitor assembly.

4. A method of manufacturing a stacked capacitor assembly, comprising:
providing a plurality of conductive substrates, wherein each of the conductive substrates has a first portion and a second portion opposite to the first portion;
arranging the conductive substrates to be spaced apart from each other;
forming an inner conductive structure for covering the first portion of each of the conductive substrates and filling between any two adjacent ones of the conductive substrates; and
forming an outermost covering structure for covering the inner conductive structure;
wherein the inner conductive structure is provided without carbon-containing materials or silver-containing materials;
wherein a space is formed between any two adjacent ones of the conductive substrates without carbon-containing materials or silver-containing materials.

5. The method according to claim 4,
wherein the step of providing the conductive substrates further includes forming a plurality of surrounding insulating layers to be respectively surroundingly disposed on the conductive substrates;
wherein each of the surrounding insulating layers is located between the first portion and the second portion of a corresponding one of the conductive substrates;
wherein in the step of arranging the conductive substrates, the surrounding insulating layers are separate from each other or connected in sequence to form an insulating barrier structure;
wherein the inner conductive structure and the outermost covering structure are connected to the surrounding insulating layers, and the inner conductive structure and the outermost covering structure are separate from the second portions of the conductive substrates by the surrounding insulating layers.

6. The method according to claim 4,
wherein the step of providing the conductive substrates further includes forming a plurality of spacers to separate the conductive substrates from each other;
wherein each of the spacers is connected between any two adjacent ones of the conductive substrates to form a space between any two adjacent ones of the conductive substrates;
wherein any two adjacent ones of the conductive substrates are separated from each other through at least one of the spacers, so that the space formed between any two adjacent ones of the conductive substrates is filled with the inner conductive structure;
wherein each of the spacers is a conductive spacer or an insulating spacer, and a thickness of a part of the inner conductive structure located between any two adjacent ones of the conductive substrates is equal to a thickness of the spacer.

7. The method according to claim 4,
wherein each of the conductive substrates is a metal foil having an oxide layer formed on a surface thereof, the inner conductive structure is a conductive polymer layer without containing carbon glue and silver glue, and the outermost covering structure includes at least one of a single carbon glue layer and a single silver glue layer;
wherein, when the outermost covering structure includes both the single carbon glue layer and the single silver glue layer, the single carbon glue layer of the outermost covering structure is allowable to be configured to cover the inner conductive structure, and the single silver glue layer of the outermost covering structure is allowable to be configured to cover the single carbon glue layer;
wherein the second portions of the conductive substrates cooperate with each other to form a positive electrode portion of the stacked capacitor assembly, and the outermost covering structure is configured to serve as a negative electrode portion of the stacked capacitor assembly.

8. A stacked capacitor package structure, comprising:
a stacked capacitor assembly including a plurality of conductive substrates, an inner conductive structure and an outermost covering structure;
an electrode assembly including a first electrode structure and a second electrode structure respectively electrically connected to the stacked capacitor assembly; and
an insulating package body configured to cover the stacked capacitor assembly and carry the electrode assembly;
wherein each of the conductive substrates has a first portion and a second portion opposite to the first portion;
wherein the inner conductive structure is configured to cover the first portion of each of the conductive substrates and be disposed between any two adjacent ones of the conductive substrates;
wherein the outermost covering structure is configured to cover the inner conductive structure;
wherein the inner conductive structure is provided without carbon-containing materials or silver-containing materials;
wherein a space is formed between any two adjacent ones of the conductive substrates without carbon-containing materials or silver-containing materials;
wherein the first electrode structure and the second electrode structure of the electrode assembly are electrically connected to the second portion of each of the conductive substrates and the outermost covering structure, respectively.

9. The stacked capacitor package structure according to claim 8,
wherein each of the conductive substrates is a metal foil having an oxide layer formed on a surface thereof, the inner conductive structure is a conductive polymer layer without containing carbon glue and silver glue, and the outermost covering structure includes at least one of a single carbon glue layer and a single silver glue layer;
wherein, when the outermost covering structure includes both the single carbon glue layer and the single silver glue layer, the single carbon glue layer of the outermost covering structure is allowable to be configured to cover the inner conductive structure, and the single silver glue layer of the outermost covering structure is allowable to be configured to cover the single carbon glue layer;
wherein the stacked capacitor assembly further includes a plurality of surrounding insulating layers, the surrounding insulating layers are configured to be respectively surroundingly disposed on the conductive substrates, and each of the surrounding insulating layers is located between the first portion and the second portion of a corresponding one of the conductive substrates;
wherein the surrounding insulating layers are separate from each other or connected in sequence to form an insulating barrier structure;
wherein the inner conductive structure and the outermost covering structure are connected to the surrounding insulating layers, and the inner conductive structure and the outermost covering structure are separate from the second portions of the conductive substrates by the surrounding insulating layers;
wherein the second portions of the conductive substrates cooperate with each other to form a positive electrode portion of the stacked capacitor assembly, and the outermost covering structure is configured to serve as a negative electrode portion of the stacked capacitor assembly;
wherein the first electrode structure and the second electrode structure of the electrode assembly are electrically connected to the positive electrode portion and the negative electrode portion of the stacked capacitor assembly, respectively;
wherein the stacked capacitor assembly is supported by a conductive carrier substrate, and the negative electrode portion of the stacked capacitor assembly is electrically connected to the second electrode structure of the electrode assembly through the conductive carrier substrate;
wherein the electrode assembly is a conductive pin assembly or a terminal electrode assembly;
wherein, when the electrode assembly is the conductive pin assembly, the first electrode structure of the electrode assembly includes a first embedded portion covered by the insulating package body and a first exposed portion connected to the first embedded portion and exposed from the insulating package body, the first embedded portion of the first electrode structure is electrically connected to the positive electrode portion of the stacked capacitor assembly, and the first exposed portion of the first electrode structure extends along an outer surface of the insulating package body;
wherein, when the electrode assembly is the conductive pin assembly, the second electrode structure of the electrode assembly includes a second embedded portion covered by the insulating package body and a second exposed portion connected to the second embedded portion and exposed from the insulating package body, the second embedded portion of the second electrode structure is electrically connected to the negative electrode portion of the stacked capacitor assembly, and the second exposed portion of the second electrode structure extends along the outer surface of the insulating package body;
wherein, when the electrode assembly is the terminal electrode assembly, the first electrode structure of the electrode assembly includes a first inner conductive layer configured to cover a first side portion of the insulating package body and electrically contact the positive electrode portion of the stacked capacitor assembly, a first intermediate conductive layer configured to cover the first inner conductive layer, and a first outer conductive layer configured to cover the first intermediate conductive layer, the first inner conductive layer is one of a silver-containing materials layer and a copper-containing material layer, the first intermediate conductive layer is a nickel-containing material layer, and the first outer conductive layer is a tin-containing material layer;
wherein, when the electrode assembly is the terminal electrode assembly, the second electrode structure of the electrode assembly includes a second inner conductive layer configured to cover a second side portion of the insulating package body and electrically contact the negative electrode portion of the stacked capacitor assembly, a second intermediate conductive layer configured to cover the second inner conductive layer, and a second outer conductive layer configured to cover the second intermediate conductive layer, the second inner conductive layer is one of a silver-containing materials layer and a copper-containing material layer, the second intermediate conductive layer is a nickel-containing material layer, and the second outer conductive layer is a tin-containing material layer.

10. The stacked capacitor package structure according to claim 8,
wherein each of the conductive substrates is a metal foil having an oxide layer formed on a surface thereof, the inner conductive structure is a conductive polymer layer without containing carbon glue and silver glue, and the outermost covering structure includes at least one of a single carbon glue layer and a single silver glue layer;
wherein, when the outermost covering structure includes both the single carbon glue layer and the single silver glue layer, the single carbon glue layer of the outermost covering structure is allowable to be configured to cover the inner conductive structure, and the single silver glue layer of the outermost covering structure is allowable to be configured to cover the single carbon glue layer;
wherein the stacked capacitor assembly further includes a plurality of spacers, and each of the spacers is connected between any two adjacent ones of the conductive substrates to form a space between any two adjacent ones of the conductive substrates;
wherein any two adjacent ones of the conductive substrates are separated from each other through at least one of the spacers, so that the space formed between any two adjacent ones of the conductive substrates is filled with the inner conductive structure;
wherein each of the spacers is a conductive spacer or an insulating spacer, and a thickness of a part of the inner conductive structure located between any two adjacent ones of the conductive substrates is equal to a thickness of the spacer;
wherein the second portions of the conductive substrates cooperate with each other to form a positive electrode portion of the stacked capacitor assembly, and the outermost covering structure is configured to serve as a negative electrode portion of the stacked capacitor assembly;
wherein the first electrode structure and the second electrode structure of the electrode assembly are electrically connected to the positive electrode portion and the negative electrode portion of the stacked capacitor assembly, respectively;
wherein the stacked capacitor assembly is supported by a conductive carrier substrate, and the negative electrode portion of the stacked capacitor assembly is electrically connected to the second electrode structure of the electrode assembly through the conductive carrier substrate;
wherein the electrode assembly is a conductive pin assembly or a terminal electrode assembly;
wherein, when the electrode assembly is the conductive pin assembly, the first electrode structure of the electrode assembly includes a first embedded portion covered by the insulating package body and a first exposed portion connected to the first embedded portion and exposed from the insulating package body, the first embedded portion of the first electrode structure is electrically connected to the positive electrode portion of the stacked capacitor assembly, and the first exposed portion of the first electrode structure extends along an outer surface of the insulating package body;
wherein, when the electrode assembly is the conductive pin assembly, the second electrode structure of the electrode assembly includes a second embedded portion covered by the insulating package body and a second exposed portion connected to the second embedded portion and exposed from the insulating package body, the second embedded portion of the second electrode structure is electrically connected to the negative electrode portion of the stacked capacitor assembly, and the second exposed portion of the second electrode structure extends along the outer surface of the insulating package body;
wherein, when the electrode assembly is the terminal electrode assembly, the first electrode structure of the electrode assembly includes a first inner conductive layer configured to cover a first side portion of the insulating package body and electrically contact the positive electrode portion of the stacked capacitor assembly, a first intermediate conductive layer configured to cover the first inner conductive layer, and a first outer conductive layer configured to cover the first intermediate conductive layer, the first inner conductive layer is one of a silver-containing materials layer and a copper-containing material layer, the first intermediate conductive layer is a nickel-containing material layer, and the first outer conductive layer is a tin-containing material layer;
wherein, when the electrode assembly is the terminal electrode assembly, the second electrode structure of the electrode assembly includes a second inner conductive layer configured to cover a second side portion of the insulating package body and electrically contact the negative electrode portion of the stacked capacitor assembly, a second intermediate conductive layer configured to cover the second inner conductive layer, and a second outer conductive layer configured to cover the second intermediate conductive layer, the second inner conductive layer is one of a silver-containing materials layer and a copper-containing material layer, the second intermediate conductive layer is a nickel-containing material layer, and the second outer conductive layer is a tin-containing material layer.
